(19) United States
(12) Patent Application Publication
(10) Pub. No.: US 2015/0111711 A1
(43) Pub. Date: Apr. 23, 2015

(54) Container for an Ice Cream Cone and Process for Preparing the Container

(71) Applicant: Conopco, Inc., d/b/a UNILEVER, Englewood Cliffs, NJ (US)

(72) Inventor: Beata Bartkowska, Bedford (GB)

(73) Assignee: Conopco, Inc., d/b/a UNILEVER, Englewood Cliffs, NJ (US)

(21) Appl. No.: 14/363,162

(22) PCT Filed: Dec. 13, 2012
(86) PCT No.: PCT/EP2012/075463

§ 371 Date: Jun. 5, 2014

(30) Foreign Application Priority Data
Dec. 15, 2011 (EP) 11193800

(51) Int. Cl. B31F 1/00; B31B 43/00

(52) U.S. Cl. CPC B31F 1/0077; B31B 43/00; B31F 1/008
USPC 493/154

(57) ABSTRACT

A process for the preparation of an ice cream cone sleeve with a rounded tip comprising the steps of: a) providing a forming element (11) having the shape of a round tipped ice cream cone with a cone angle a, and also providing a forming cavity (12) having an internal surface corresponding to the shape of the forming element (11), b) placing a cone sleeve (10) having a cone angle a within the forming cavity (12), c) engaging the forming element (11) within the cone sleeve (10), and d) forcing the forming element (11) and the forming cavity (12) together wherein the cone sleeve has a frustoconical shape and an open tip (10b) and wherein the end of the sleeve (10) protrudes beyond the end of the forming element (11) in step c).

### TECHNICAL FIELD

The present invention relates to a process for the manufacture of a sleeve for an ice cream cone. In particular, the invention relates to a process for the production of a sleeve for an ice cream cone having a rounded tip.

### BACKGROUND TO THE INVENTION

Ice cream cone products such as Cornetto are well known and popular with consumers. Such products comprise a wafer cone, typically coated on the inside with a chocolate-based material, and filled with a frozen confection. These cones are typical ice cream cones with an opening at one end and a point at the other. More specifically these cones are hollow 3-dimensional objects with a circular opening at one end into which the frozen confection is introduced and a single vertex at the other end where the wall of the cone terminates at its point. The “cone angle” describes the angle at the point of the cone and can be readily ascertained by measuring the angle formed between the opposing parts of the cone wall at the tip. Typically ice cream cones have an acute cone angle, somewhere in the region of 20 to 40°.

Products such as Cornettos are provided in a sleeve in which the cone sits and which is usually made from a paper-based material such as cardboard. The sleeve serves to support and protect the cone and its contents during production and also protects the final product in the supply chain. During consumption the sleeve also provides a holder for consumers, allowing them to eat the product without necessarily making contact with the cone itself.

Cone sleeves are normally made from a blank which, prior to rolling has a shape akin to an isosceles triangle but where the third edge is a curve. More specifically such a blank has the form of a circular sector which can be described by taking two lines from the centre of a circle out to the edge. These lines form two edges of the circular sector and each have a length equal to the radius of the circle. The other edge of the sector is the arc of the circle between the two lines. The central angle θ of the sector is the angle formed between the two lines where they meet at the centre of the circle. For the sake of clarity, a sector with a central angle of 180° is a semicircle, quadrants have a central angle of 90°, sextants have a central angle of 60°, and octants have a central angle of 45°. When such blanks are rolled to form the cone shape they will form a pointed tip and are suitable as sleeves for cones having a similar shape.

However, consumers are increasingly demanding new and interesting product formats and new cone shapes are being developed. Round tipped cones are one such cone shape. In these variants the cone does not have a point where the wall of the cone terminates. Instead, the cone has a large, rounded tip.

Existing sleeve blanks and the resulting sleeves, and the associated sleeve forming apparatuses and processes are mainly directed towards forming traditional cone sleeves having a pointed tip. Such sleeves are unsuitable for round tipped cones. As can be appreciated, if a round tipped cone is placed in a standard cone sleeve the rounded tip of the cone will not extend to the tip of the sleeve and there will be a void at the bottom of the sleeve. The tip of the cone sleeve is therefore not filled with the tip of a cone and is easily damaged during manufacture, transport and storage. Furthermore, the visual cue of the round tipped cone which has been carefully manufactured will be completely hidden if a standard pointed cone sleeve is used. DE228330 describes an apparatus for forming a container from a paper sleeve.

There is therefore a need for an apparatus and process for the production of sleeves having a rounded tip that can be used with round tipped cones.

### SUMMARY OF THE DRAWINGS

FIG. 1 shows a standard ice cream cone.

FIG. 2 shows a cross section of a standard ice cream cone.

FIG. 3 shows a blank for a standard ice cream cone sleeve.

FIG. 4 shows a round tipped ice cream cone.

FIG. 5 shows a cross section of a round tipped ice cream cone.

FIG. 6 shows a representation of the geometry of a round tipped cone sleeve forming element.

FIG. 7 shows a round tipped cone sleeve forming apparatus.

FIG. 8 shows the apparatus of FIG. 7 in use for forming a round tipped cone sleeve.

FIG. 9 shows a standard cone sleeve that may be altered for use in the process of the present invention.

FIG. 10 shows a disc sector cone sleeve blank for use in the process of the present invention.

### SUMMARY OF THE INVENTION

We have now found that cone sleeves having a rounded tip can be formed by using a specific process and apparatus.

Accordingly, the application describes an apparatus for the preparation of an ice cream cone sleeve having a cone angle a and a rounded tip, the apparatus comprising a forming element having the shape of a round tipped ice cream cone with a cone angle α, and a forming cavity with an internal surface that corresponds to the shape of the forming element.

Preferably the forming element has a channel through which a gas can be blown.

Preferably the forming element has at least one annular ridge on the surface.

Preferably the inner surface of the forming cavity is smooth.

The invention provides a process for the preparation of an ice cream cone sleeve with a rounded tip comprising the steps of:
a) providing a forming element having the shape of a round tipped ice cream cone with a cone angle a and also providing a forming cavity having an internal surface corresponding to the shape of the forming element,
b) placing a cone sleeve having a cone angle a within the forming cavity,
c) engaging the forming element within the cone sleeve, and
d) forcing the forming element and the forming cavity together wherein the cone sleeve has a frustoconical shape and an open tip and wherein the end of the sleeve protrudes beyond the end of the forming element in step c).

Preferably the tip of the sleeve protrudes beyond the end of the forming element in step c) by a distance of from 55% to 100% of the length of the arc of the rounded tip of the forming element.

Preferably the frustoconical cone sleeve is formed from a cone blank having a disc sector shape.

The invention also provides a cone sleeve obtained or obtainable by the process of the invention.

The invention further provides a cone sleeve having a rounded tip.

Preferably the rounded tip of the cone comprises a chaos fold.

The application also describes a blank in the form of a disc sector for making an ice cream cone sleeve having a rounded tip.

### DETAILED DESCRIPTION OF THE INVENTION

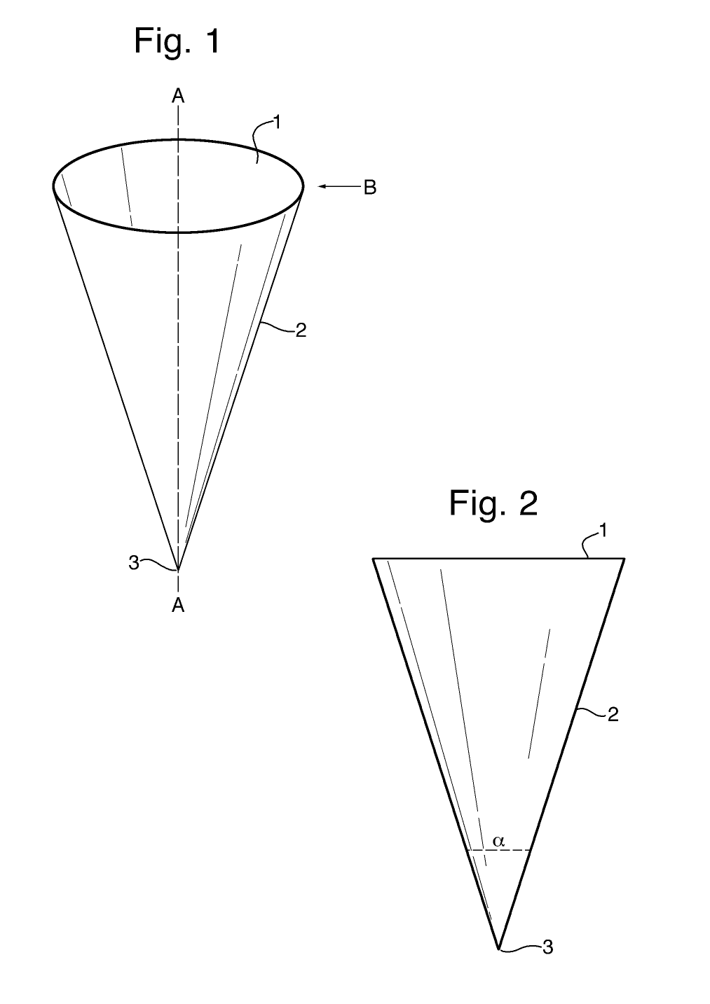

At typical ice cream cone is shown in FIG. 1. Such cones have an open end 1, a wall 2 and a pointed tip 3. Cones can be characterised by the “cone angle” which is the angle at the point of the cone and can be readily ascertained by measuring the angle formed between the opposing parts of the cone wall at the tip. FIG. 2 shows a cross section of the cone of FIG. 1 cut along the plane indicated by line A-A and viewed from point B as indicated by the arrow. The cone angle a is indicated in FIG. 2 by the dotted line at the tip of the cone.

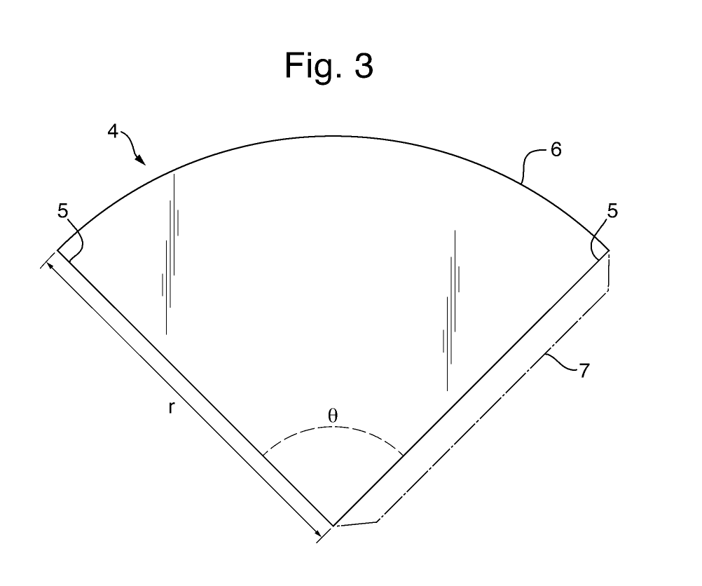

Sleeves for such cones can be formed from a cone blank 4 such as that shown in FIG. 3. As can be seen, such blanks have the form of a circular sector which can be described by taking two lines 5 from the centre of a circle out to the edge 6. These lines form two edges of the circular sector and each have a length equal to the radius of the circle (denoted r in FIG. 3). The other edge of the sector is the arc of the circle 6 between the two lines. The central angle θ of the sector is the angle formed between the two lines where they meet at the centre of the circle. Blanks can also be provided with a tab 7 which can facilitate gluing or similar fixative when the blank is rolled to form the cone shaped sleeve. The resulting sleeve will have walls of length r and will have a pointed tip. Such a sleeve will also have an cone angle which can easily be determined as described above. Ice cream cones are optimally packaged in sleeves that have a similar cone angle to ensure a snug fit between the package and the product.

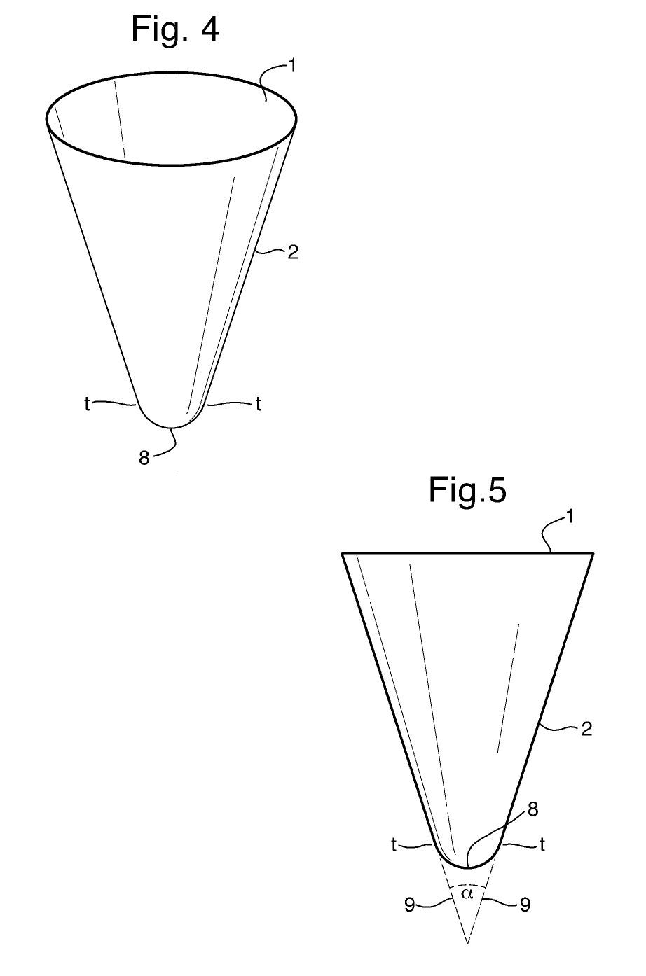

Round tipped cones are a novel and attractive format for consumers and represent a departure from the standard pointed ice cream cones. An example of a round tipped cone is shown in FIG. 4. These cones also have an opening 1 at one end and a wall 2 but differ from standard cones because the tip does not end in a point at the vertex. The walls 2 taper towards the tip but, rather than continuing to a vertex, they then curve inwards at a turning point “t” to form a rounded tip 8.

The walls of such round tipped cones still form a cone angle as shown in FIG. 5 which demonstrates that the cone angle a is determine by projecting the path 9 of the straight part of the wall prior to the turning point “t” and measuring the angle a at the intersection of these projections 9.

Such round tipped cones require correspondingly shaped cone sleeves. It is conceivable that standard pointed cone sleeves could be used with a round tipped cone provided that both the sleeve and the cone have similar cone angles to ensure that the cone would fit well within the sleeve. However it can readily be appreciated that such a combination would immediately mask the fact that the cone had the attractive rounded tip. Furthermore, there would be a significant void between the end of the rounded cone and the pointed tip of the sleeve.

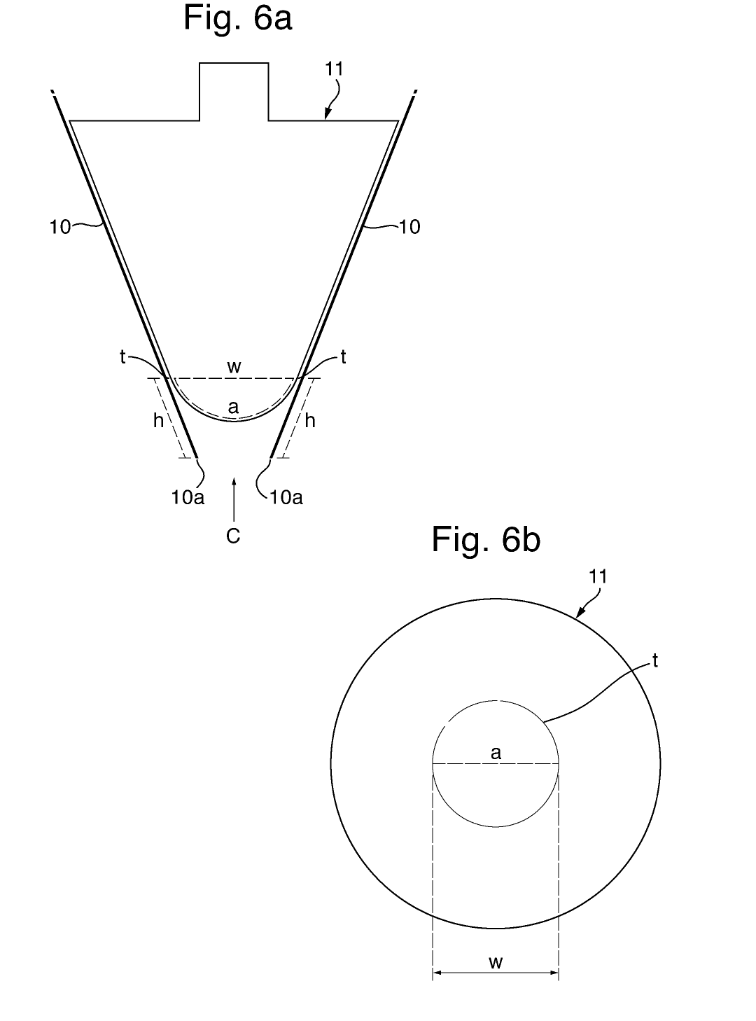

In order to overcome such disadvantages, an apparatus has been developed. The apparatus is able to create round bottomed cone sleeves effectively and very efficiently. The apparatus has a forming element which has same shape as the round bottomed cone that is to be enclosed in the sleeve made using the apparatus. By same shape it is meant that the forming element and the round bottomed cone both have the same key cone features as described in FIGS. 6a and 6b. FIG. 6a shows a cross section of a forming element 11. The cone forming element 11 has straight walls tapering inwards towards a rounded tip. The walls curve inwards at turning point “t”. The forming element 11 has a width “w” at the turning point. The arc across the surface of the rounded tip is denoted “a” and is measured from the turning point “t” at one side of the element 11 to turning point “t” on the opposite face. FIG. 6b is an alternative view of the forming element 11 of FIG. 6a viewed from beneath as indicated by arrow C. For the sake of clarity, the sleeve 10 is not shown in FIG. 6b. The features of the forming element apply equally to the cone that the forming element corresponds to.

If a sleeve is required for a round tipped cone that has a cone angle a and that has a rounded tip with a width “w” and an arc “a” then the forming element would have a similar cone angle a and its rounded tip would have a width approximately the same as “w” and an arc of about “a”. Preferably the features a, “w” and “a” of the cone and the forming element are within 10% of each other, more preferably 5%, most preferably within 2%.

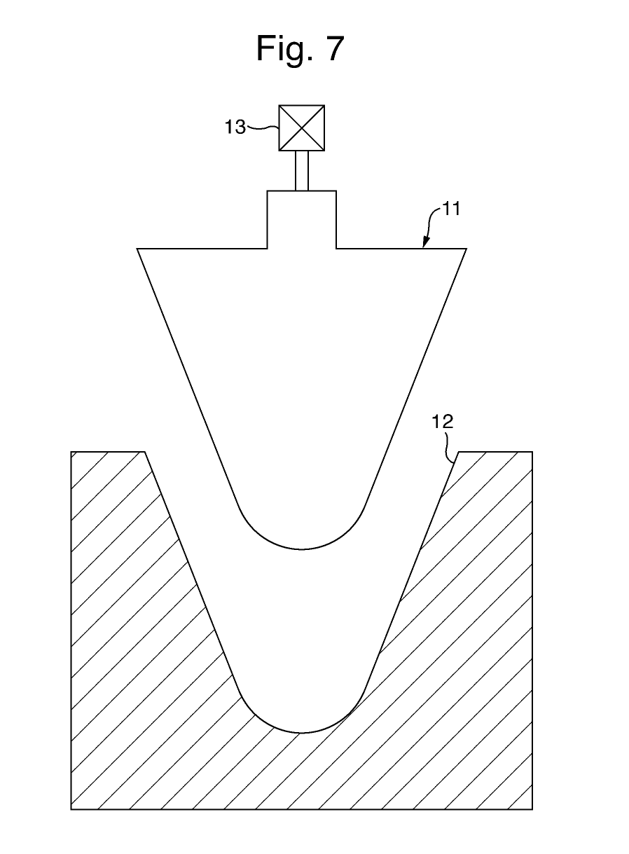

A forming element 11 is shown in combination with a forming cavity 12 in FIG. 7. The internal surface of the forming cavity corresponds to the shape of the forming element such that when the forming element 11 is placed within the forming cavity 12 a snug fit is achieved. The apparatus may also have a control means 13 which controls how the forming element 11 moves into and out of the forming cavity 12.

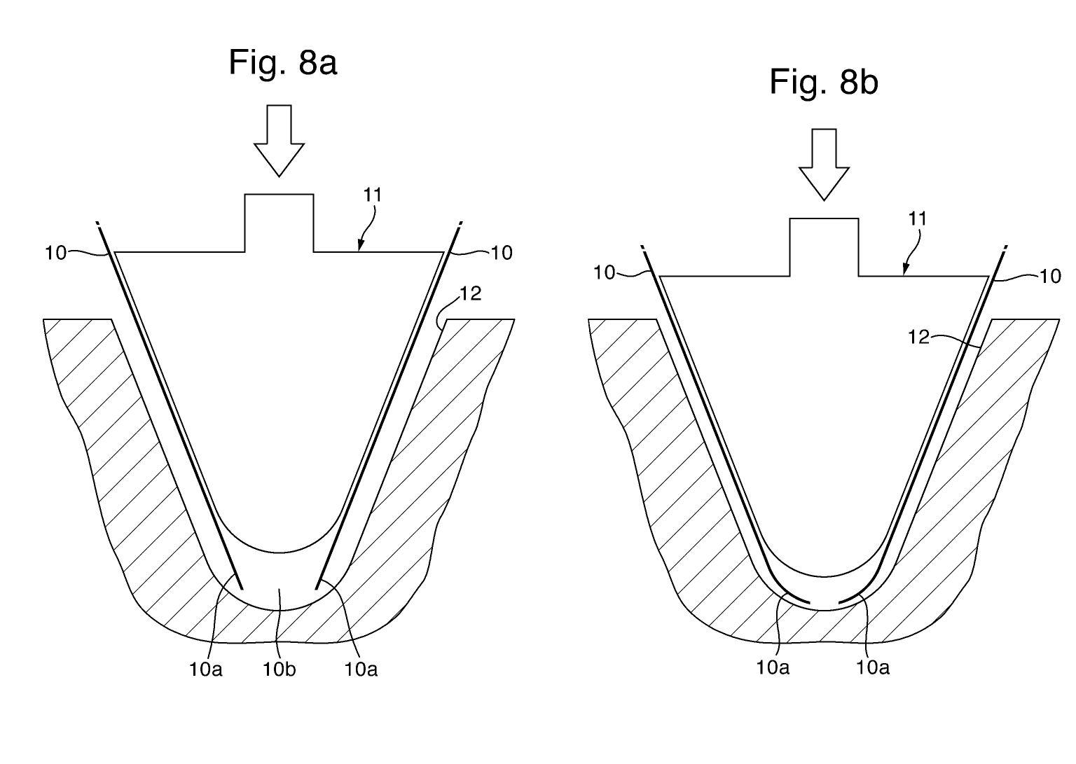

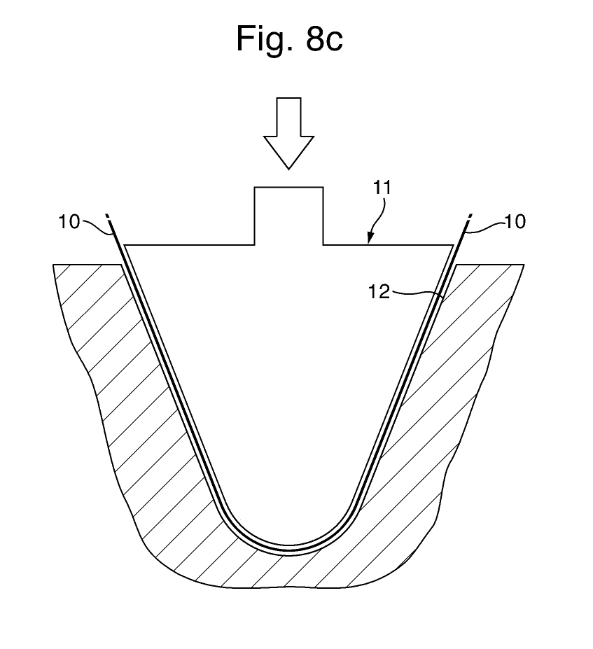

FIG. 8 shows in cross section the forming apparatus in use and describes the process for forming a sleeve for a round tipped cone. In FIG. 8a a sleeve 10 has been placed within the forming cavity 12 and the forming element 11 has been lowered into the forming cavity 12 to engage with the sleeve 10. By engaged it is meant that the walls of the forming element 10 are in contact with the internal surface the sleeve 10. Although the forming element 11 is shown as moving downwards into the forming cavity 12, the forming cavity can also be brought upwards towards the forming element 11. As can be seen, the walls of the forming element 11, the forming cavity 12 and the sleeve 10 are all substantially parallel because all three have similar cone angles. Furthermore, the cone sleeve has a frustoconical shape with an open tip 10b and the end of the sleeve 10a protrudes beyond the end of the forming element 11.

As shown in FIG. 8b, as the forming element 11 is forced into the forming cavity 12, either by moving the element 11 downwards or the cavity 12 upwards, the end of the sleeve 10a is forced between the rounded tip of the forming element 11 and the rounded base of the forming cavity 12. The end 10a therefore begins to deform around the rounded tip of the forming element. When the forming element 11 has been fully forced into the forming cavity 12 the sleeve 10 has wrapped itself around the rounded tip of the forming element 11 as shown in FIG. 8c. The forming element can then be removed and a rounded tipped cone can be placed into the sleeve before moving along a production line to be filled with a frozen confection product.

This process results in a very tight seal at the base of the newly formed sleeve. The use of pressure between the forming cavity 12 and element 11 provides a chaos fold at the tip of the sleeve. As chaos fold is an unstructured or random folding pattern, as opposed to a regular and consistent fold such as those used in crimping of the construction of containers from blanks. The chaos fold in the present invention is achieved by unstructured or random packing of the end 10a of the cone sleeve which itself results from the compaction of the end 10a between the surfaces of the forming element 11 and forming cavity 12. We have surprisingly found that this type of fold is very resilient. It provides structural support to the base of the sleeve and protects the product within. The random nature of the fold also allows interlinking between the various parts of the folds which acts to hold together the newly formed tip. Normally such self-binding folds can only be achieved through extremely delicate and complex folding techniques that cannot be incorporated into an industrial ice cream manufacturing line. In addition, the pressure between the element 11 and the cavity 12 on the rounded tip of the sleeve 10 creates a sealed end that is substantially air tight. This feature allows for air pressure to be used to remove the formed sleeve from the forming element. In order to assist in this the forming element 11 may have a channel through which air can be blown from the region of the rounded tip of the forming element which gently forces the sleeve 10 from the element. If it is desired to move the sleeve from the forming cavity 12 then the forming element can be provided with annular rings on its surface which can engage with the sleeve 10 when formed and hence the sleeve can be moved with the forming element 11 to another location on the production line before being removed using, for example, a pulse of air as described.

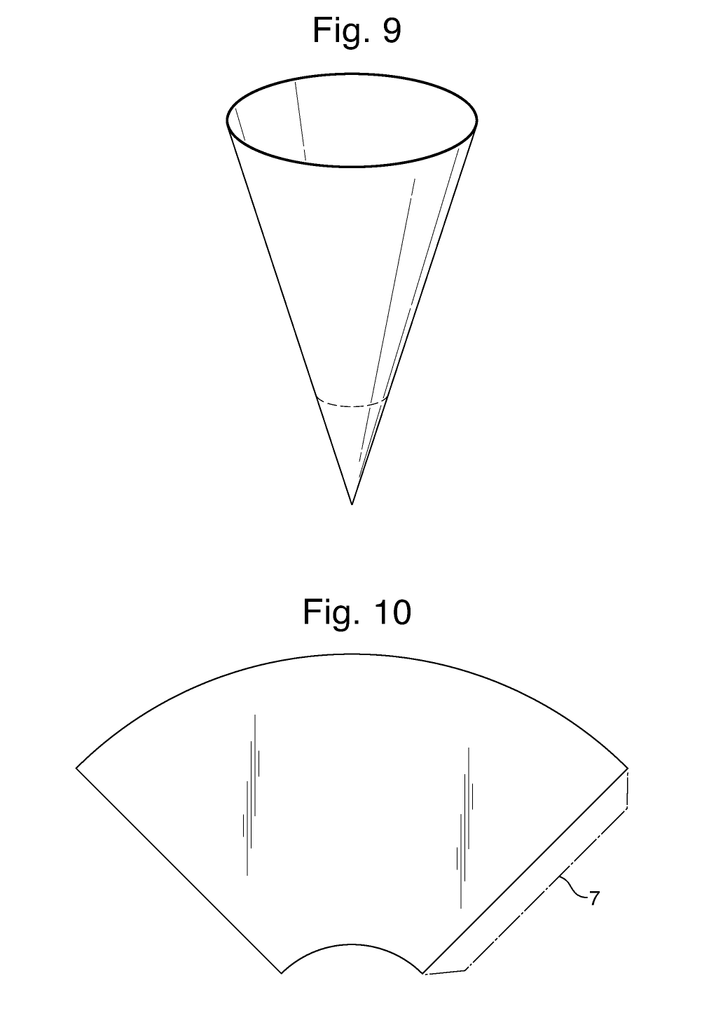

It has been found that the frustoconical nature of the sleeve 10 is a useful aspect of this invention. If a standard pointed cone sleeve was placed into the forming cavity 12 and compressed by the forming element 11 it would have an excess of material at the tip of the sleeve which could sterically interfere with the cone when it is introduced. In order to overcome such steric hindrance, the forming element and forming cavity could be forced together using higher pressure in order to increase the compression of the excess sleeve material. However, such increases in pressure can slow the process and require increases in energy. Frustoconical sleeves with an open tip have less excess material at the tip and therefore the issues arising with the use of standard pointed cone sleeves are overcome. Frustoconical sleeves can be made by removing the tip from a standard cone sleeve. FIG. 9 shows the dotted line along which a cut would be made to remove the tip of a pointed cone sleeve to produce the frustoconical cone sleeve having an open tip as used in this invention.

Alternatively, a disc sector blank as shown in FIG. 10 can be used. This blank differs from the standard circular sector blank as described above in that the straight edges of the disc sector do not join to form a point which corresponds to the centre of a circle from which the blank is cut. Rather they each terminate at the end of an inner arc. When such a blank is rolled up and fixed, the shape means that the resulting sleeve will have a frustoconical shape and an open ended tip. The blank can optionally be provided with a tab 7 as indicated by the dotted lines which will facilitate fixing the sleeve when the blank is rolled to form the frustoconical sleeve.

As discussed, when the frustoconical sleeve 10 is placed on the forming element the end of the sleeve protrudes beyond the end of the forming element. As shown in FIG. 6a the length of the protrusion should be sufficient to ensure that the rounded tip of the forming element is completely covered. It is therefore preferred that the length of the protrusion “h” is greater than 50% of the length of the arc “a” of the rounded tip of the forming element. Hence, when the protruding part of the cone sleeve is deformed around the forming element there is sufficient material to provide a seal at the end of the cone sleeve. More preferably, the length of the protrusion “h” is at least 60% of “a”, more preferably still at least 75% of “a”. In order to ensure that the base of the sleeve does not have too much excess material that might interfere with the packaging of the round tipped cone, the length of the protrusion “h” is preferably at most 150% of “a”, more preferably at most 125% of “a”, most preferably at most 100% of “a”.

1. A process for the preparation of an ice cream cone sleeve (1) with a rounded tip (4) comprising the steps of:
a) providing a forming element (11) having the shape of a round tipped ice cream cone with a cone angle a, and also providing a forming cavity (12) having an internal surface corresponding to the shape of the forming element (11),
b) placing a cone sleeve (10) having a cone angle a within the forming cavity (12),
c) engaging the forming element (11) within the cone sleeve (10), and
d) forcing the forming element (11) and the forming cavity (12) together wherein the cone sleeve has a frustoconical shape and an open tip (10b) and wherein the end of the sleeve (10) protrudes beyond the end of the forming element (11) in step c).

2. A process according to claim 1 wherein the tip of the sleeve (10a) protrudes beyond the end of the forming element (11) in step c) by a distance of from 55% to 100% of the length of the arc of the rounded tip of the forming element (11).

3. (canceled)

4. (canceled)

5. (canceled)

6. (canceled)

7. A process according to claim 1 wherein the tip of the frustoconical cone sleeve (10) is formed from a cone blank having a disc sector shape.
